(19) United States
(12) Patent Application Publication
(10) Pub. No.: US 2013/0097565 A1
(43) Pub. Date: Apr. 18, 2013

(54) LEARNING VALIDATION USING GESTURE RECOGNITION

(71) Applicants: Aimee Freeding, London (GB); Brian Stone, London (GB); Matthew White, Cambridgeshire (GB); Joshua Whitney Samuels Atkins, London (GB)

(72) Inventors: Aimee Freeding, London (GB); Brian Stone, London (GB); Matthew White, Cambridgeshire (GB); Joshua Whitney Samuels Atkins, London (GB)

(73) Assignee: MICROSOFT CORPORATION, Redmond, WA (US)

(21) Appl. No.: 13/275,134

(22) Filed: Oct. 17, 2011

(51) Int. Cl. G06F 3/033

(52) U.S. Cl. 715/863

(57) ABSTRACT

Embodiments are disclosed that relate to assessing a user's ability to recognize a target item by reacting to the target item and performing a target gesture. For example, one disclosed embodiment provides a method of assessing a user's ability to recognize a target item from a collection of learning items that includes the target item. The method includes providing to a display device the learning items in a sequence and receiving input from a sensor to recognize a user gesture made by the user. If the user gesture is received within a target timeframe corresponding to the target item, then the method includes determining whether the user gesture matches a target gesture. If the user gesture matches the target gesture, then the method includes providing to the display device a reward image for the user.

### BACKGROUND

Educational video games may present users with learning material and associated challenges that facilitate the learning of the material. Some educational video games may also gauge a user's retention of the learning material, such as by monitoring correct and incorrect answers in a testing session. With some users, for example children, interactive video games may provide an engaging experience that is conducive to learning.

### SUMMARY

Embodiments are disclosed that relate to assessing a user's ability to recognize a target item by reacting to the target item and performing a target gesture. For example, one disclosed embodiment provides a method of assessing a user's ability to recognize a target item from a collection of learning items that includes the target item. The method comprises providing to a display device the learning items in a sequence, and while providing the learning items to the display device, receiving input from a sensor to recognize a user gesture made by the user. The method includes determining whether the user gesture is received within a target timeframe corresponding to the target item. If the user gesture is received within the target timeframe, then the method includes determining whether the user gesture matches a target gesture. If the user gesture matches the target gesture, then the method includes providing to the display device a reward image for the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a user performing a gesture in an example embodiment of a media presentation environment in which a method of assessing the user's ability to recognize a target item may be performed.

FIG. 2 shows an example embodiment of a computing system that may be used in the media presentation environment of FIG. 1.

FIGS. 3A and 3B show a flow chart of an example embodiment of a method of assessing a user's ability to recognize a target item from a collection of learning items.

### DETAILED DESCRIPTION

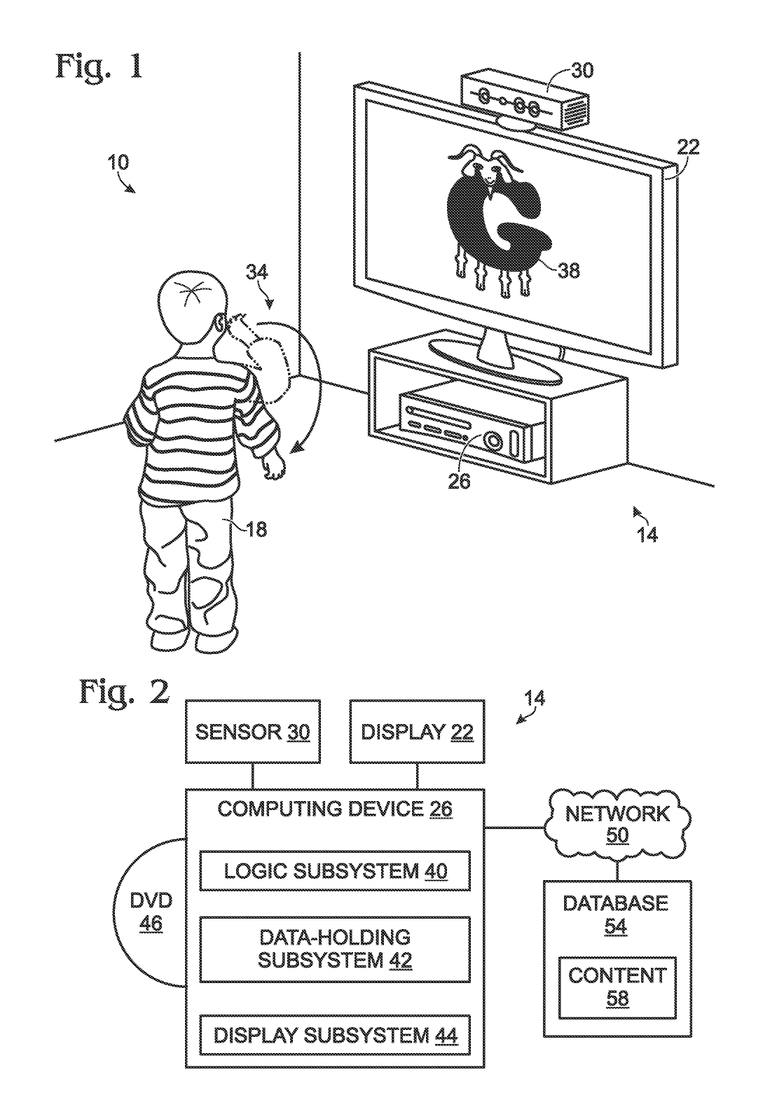

Embodiments are disclosed that relate to assessing a user's ability to recognize a target item by reacting to the target item and performing a target gesture. With reference to FIG. 1, an example embodiment of a media presentation environment 10 may include a computing system 14 that enables a user 18, illustrated here as a child, to interact with a video game, such as an educational video game, or other media presentation. It will be appreciated that the computing system 14 may be used to play a variety of different games, play one or more different media types, such as linear video and audio, and/or control or manipulate non-game applications and/or operating systems.

The computing system 14 includes computing device 26, such as a video game console, and a display device 22 that receives media content from the computing device. Other examples of suitable computing devices 26 include, but are not limited to, set-top boxes (e.g. cable television boxes, satellite television boxes), digital video recorders (DVRs), desktop computers, laptop computers, tablet computers, home entertainment computers, network computing devices, and any other device that may provide content to a display device 22 for display.

The computing system 14 may also include a sensor 30 that is coupled to the computing device 26. In some embodiments, the sensor 30 may be separate from the computing device as shown in FIG. 1, while in other embodiments the sensor may be integrated into the computing device 26. The sensor 30 may be used to observe objects in the media presentation environment 10, such as user 18, by capturing image data and distance, or depth, data. In one example, the sensor 30 may comprise a depth camera that interprets three-dimensional scene information from continuously-projected infrared light. Examples of depth cameras may include, but are not limited to, time-of-flight cameras, structured light cameras, and stereo camera systems.

Data from the sensor 30 may be used to recognize a user gesture 34 made by the user 18. In the example shown in FIG. 1, the user gesture 34 is a throwing motion that may simulate, for example, throwing an imaginary ball toward a target item 38 displayed on the display device 22. It will be appreciated that data from the sensor 30 may be used to recognize many other gestures, motions or other movements made by the user 18 including, but not limited to, one or more limb motions, jumping motions, clapping motions, head or neck motions, etc.

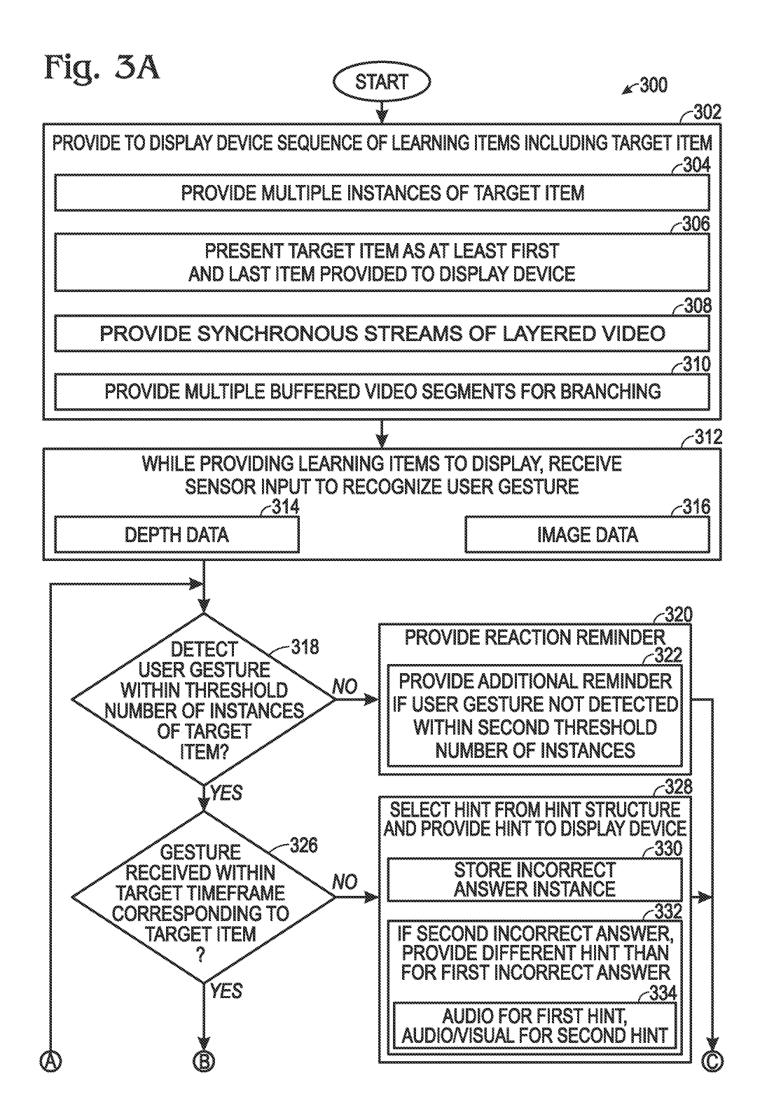

With reference now to FIG. 2, an example embodiment of the computing system 14 and associated computing device 26 will now be described. The computing device 26 comprises a logic subsystem 40 configured to execute instructions and a data-holding subsystem 42 configured to hold instructions executable by the logic subsystem. Such instructions may implement various tasks and achieve various methods and functions described herein, including but not limited to assessing a user's ability to recognize a target item by reacting to the target item and performing a target gesture. The computing device 26 also includes a display subsystem 44 that may be used to present a visual representation of data held by the data-holding subsystem 42, such as via the display device 22.

FIG. 2 also shows an aspect of the data-holding subsystem 42 in the form of removable computer-readable storage media 46, shown here in the form of a DVD. The removable computer-readable storage media 46 may be used to store and/or transfer data, including but not limited to media content, and/or instructions executable to implement the methods and processes described herein. The removable computer-readable storage media 46 may also take the form of CDs, HD-DVDs, Blu-Ray Discs, EEPROMs, and/or floppy disks, among others.

It will also be appreciated that media content and other data may be received by the computing device 26 from one or more remote content sources, illustrated in FIG. 2 as database 54 containing remote content 58, accessible via computer network 50. The database 54 may represent any suitable content source, including but not limited to cable television providers, satellite television providers, on-demand video providers, web sites configured to stream media, etc. The network 50 may take the form of a local area network (LAN), wide area network (WAN), wired network, wireless network, personal area network, or a combination thereof, and may include the Internet. Additional details on the computing aspects of the computing device 26 are described in more detail below.

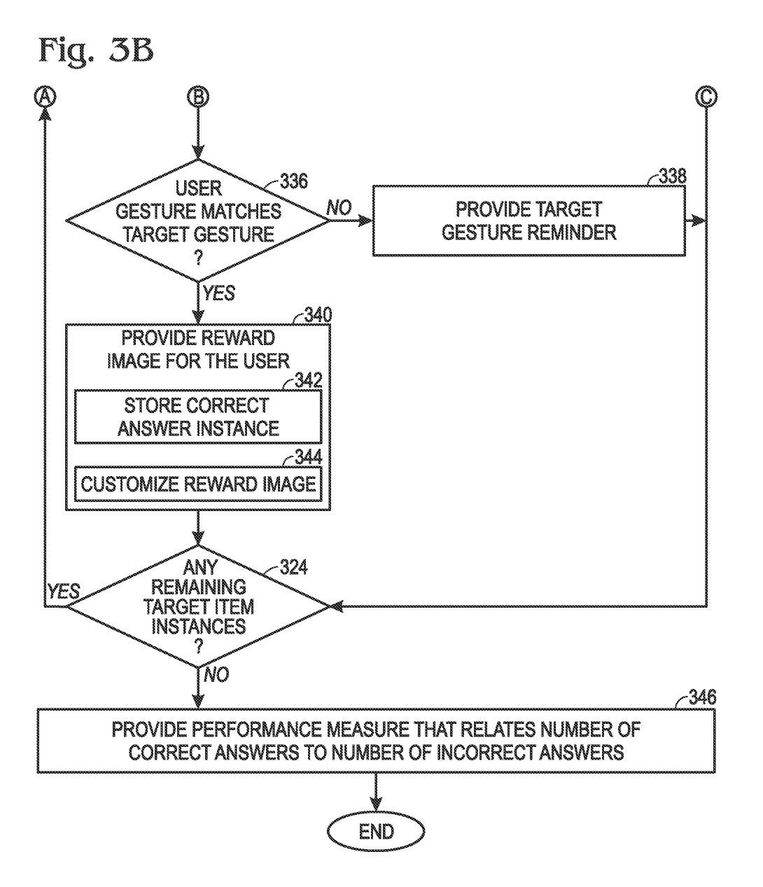

With reference now to FIGS. 3A and 3B, a flow chart of an example embodiment of a method 300 of assessing a user's ability to recognize a target item from a collection of learning items is provided. The method 300 may be performed using the hardware and software components of the computing system 14 described above and shown in FIGS. 1 and 2, or using any other suitable components. For convenience of description, the method 300 will be described herein with reference to the components of computing system 14.

It will be appreciated that in some embodiments, method 300 may be performed as one or more segments within a learning episode or program designed to teach educational material to the user 18. For example, an interactive educational video may be designed to teach children to learn letters of an alphabet and/or numbers. At the beginning of the educational video, a passive video segment may introduce one or more letters and/or numbers to the child. Thereafter, at one or more segments of the educational video, the method 300 may be performed to assess the child's ability to recognize the letters and/or numbers previously presented. In the following description, these segments during which the method 300 may be performed will referred to as assessment segments.

As a more specific example, a passive video segment may introduce one Letter of the Day and one Number of the Day to the user 18. The method 300 may then be performed at one point during the video to assess the user's ability to recognize the Letter of the Day, and at another point during the video to assess the user's ability to recognize the Number of the Day. In another example, one or more of the letters and/or numbers may be presented as stylized characters, such as the target item 38 illustrated in FIG. 1 as the letter “G” having a goat-like head and goat-like legs. The letters and/or numbers may also be animated to move around, on, and/or off the display device 22. In another example, the letters and/or numbers may have certain personalities or characteristics that relate to the letter or number. With respect to letters, for example, such personalities may reflect words that begin with that letter, such as the stylized “G” resembling a goat. Further, the letters and/or numbers may interact with one another as they move around, on and off the display device 22.

It will also be appreciated that in some embodiments, method 300 may include a process for determining whether a user 18 is present and ready to participate in an assessment segment. For example, data from the sensor 30 may be used to determine how many users are present in the media presentation environment 10. If more than one user 18 is present, then a separate multi-user game may be provided to the display device 22 for display to the users. If no users are present, then a user absent experience video may be provided to the display device 22 for display to the media presentation environment 10. If no users are found after a predetermined time, such as 5 minutes, 10 minutes, or any other suitable time, then a second user absent experience video may be provided to the display device 22.

If a user 18 is found before the second user absent experience video is completed, then it may be determined whether the user is ready to participate in an assessment segment. If the user 18 is not ready to participate, then a user passive experience video may be provided to the display device. If the user 18 is still not ready to participate after a predetermined time, such as 10 minutes, then a second user passive experience video may be provided to the display device 22.

If it is determined that the user 18 is ready to participate, then in some embodiments the method may provide an assessment segment introduction video to the display device 22. In one example, the assessment segment introduction video may introduce and explain to the user 18 an assessment challenge game that assesses the user's ability to recognize a Letter of the Day or a Number of the Day from a sequence of letters or numbers provided to the display device 22. The user 18 may be instructed to perform a particular gesture or movement, hereinafter referred to as a target gesture, when the user sees the Letter or Number of the Day. In this manner, the method 300 may also assess an ability of the user 18 to perform two skills at one time—in this case, recognizing the Letter or Number of the Day and performing a target gesture in response to recognizing the Letter or Number of the Day.

In one example, the target gesture may comprise the user jumping in place. In another example, the target gesture may comprise a throwing motion that may simulate throwing an imaginary ball toward the target item 38 displayed on the display device 22 (with such target gesture illustrated in FIG. 1 as user gesture 34). As with the user gesture 34 described above, it will be appreciated that the target gesture may comprise any gesture, motion or other movement made by the user 18 that may be captured by the sensor 30 including, but not limited to, one or more limb motions, jumping motions, clapping motions, etc.

In a more specific example, the user 18 may be asked to practice the target gesture and data from the sensor 30 may be used to determine whether the user performs the target gesture. If the user 18 does not perform the target gesture, an additional tutorial video explaining and/or demonstrating the target gesture may be provided to the display device 22. If the user 18 performs the target gesture, then an assessment segment may commence.

Turning now to FIG. 3A, a flow chart of an example embodiment of a method 300 of assessing a user's ability to recognize a target item from a collection of learning items will now be described. At 302, the method 300 includes providing to display device 22 a collection of learning items in a sequence, with the learning items including target item 38. As described above, the target item 38 may comprise a letter or number, or may be any suitable learning element or character. The collection of learning items may be other items of a similar nature to the target item 38. For example, where target item 38 is the letter “G” as illustrated in FIG. 1, the collection of learning items may include other letters of the English alphabet that are provided in a sequence to the display device 22.

In some embodiments, multiple instances of the target item 38 may be provided to the display device 22 within the sequence of learning items, as indicated at 304. For example, where the target item 38 is the letter “G”, a sequence of 5 letters that contains 2 instances of the target item 38, such as “D, G, B, G, P”, may be provided to the display device 22. It will be appreciated that many different lengths of sequences may be used that contain more or less than 5 characters, such as 3 characters, 7 characters, 9 characters, and other lengths. It will also be appreciated that many different numbers of instances of the target item 38 may be used within a sequence. For example, a sequence of 5 letters may contain 3 instances of the target item 38, a sequence of 11 letters may contain 5 instances of the target item, etc. It will also be appreciated that various combinations of sequence lengths and instances of the target item may be used.

Further, any suitable manner of presenting the sequence of learning items to the user may be used. For example, each learning item may be displayed individually, one-at-a-time on the display device 22, or two or more learning items may be displayed simultaneously or with some overlap in the display of each learning item. In another example, the learning items may appear on the display device 22 by entering from one side or edge of the display device, and may remain on the display device for a predetermined period of time, such as 1 second, 3 seconds, 5 seconds, or other suitable time. The learning item may also exit the display device 22 by moving to the left, right, top or bottom of the display device until the learning item is no longer visible.

In some embodiments, the target item 38 may be presented as at least a first learning item and a last learning item provided to the display device 22 in the sequence, as indicated at 306. For example, where the target item 38 is the letter “G”, a sequence of 5 letters that contains the target item 38 as the first item and the last item in the sequence, such as “G, D, P, D, G”, may be provided to the display device 22. It will be appreciated that a sequence may also include other instances of the target item 38 in addition to the target item being the first item and the last item in the sequence.

In some embodiments, the sequence of learning items may be provided to the display device 22 as video content comprising multiple layers of video that are synchronously streamed to the display device, as indicated at 308. In other embodiments, the sequence of learning items may be provided to the display device 22 by branching between at least a first buffered video content and a second buffered video content, as indicated at 310. It will be appreciated that the sequence of learning items may be provided to the display device 22 by branching to additional buffered video content.

Continuing with FIG. 3A, while providing the sequence of learning items to display device 22, the method 300 includes receiving input from the sensor 30 to recognize the user gesture 34 made by the user 18, as indicated at 312. As explained above with reference to FIG. 1, the user gesture 34 may be a throwing motion that may simulate, for example, throwing an imaginary ball toward the target item 38 displayed on the display device 22. It will be appreciated that data from the sensor 30 may be used to recognize many other gestures, motions or other movements made by the user including, but not limited to, one or more limb motions, jumping motions, clapping motions, etc. Also as explained above, any suitable sensor 30 may be used to recognize and capture the user gesture 34. For example, in some embodiments, a depth camera may be used to capture depth/distance data, as indicated at 314, and/or image data, as indicated at 316.

At 318, the method includes using input received from the sensor 30 to detect whether the user gesture 34 is received within a threshold number of instances of the target item. In one embodiment, if the user gesture 34 is not received within a first threshold number of instances of the target item, then a first reaction reminder may be provided to the user 18, as indicated at 320. In one example, the first reaction reminder may comprise audio feedback, such as a voice over prompt provided via display device 22, that encourages the user to react when the user sees the target item. As a specific example, the voice over prompt may tell the user 18, “Don't forget to throw your ball when you see the letter G.” The first threshold number of instances may be 1, 2, 3 or any other suitable number of instances.

After providing the first reaction reminder, and with reference to 324 in FIG. 3B, the method 300 may determine whether there are any remaining target item instances to be provided to the display device 22. If there are remaining target items to be provided to the display device 22, then the method 300 may continue detecting whether a user gesture 34 is received within a threshold number of instances of the target item, at 318. If there are no remaining target items to be provided to the display device 22, then the method 300 may provide to the display device 22 a performance measure that relates a number of correct answer instances provided by the user 18 to a total number of instances of the target item that were provided to the display device 22 during the assessment segment. In some embodiments, the performance measure may comprise a ratio of the number of correct answer instances to the total number of instances of the target item that were provided to the display device 22. In other embodiments, the method may evaluate a consistency of performance of the user 18 across multiple assessment segments involving the same target item. After providing the performance measure, the method 300 may end.

Returning to FIGS. 3A and 322, in other embodiments if the user gesture 34 is not received within a second threshold number of instances of the target item, a second reaction reminder different from the first reaction reminder may be provided to the user 18 via display device 22. In one example, the second reaction reminder may comprise audio and visual feedback, such as a character appearing on the display device 22 who provides additional encouragement to the user 18 to react when the user sees the target item. In a more specific example, the character may tell the user 18, “We want to learn the letter G, so don't forget to throw your ball when you see the letter G.” The character may also demonstrate the target gesture as the letter G appears on the display device 22. The second threshold number of instances may be 2, 3, 4 or any other suitable number of instances. After providing the second reaction reminder, the method 300 may proceed to determine whether there are any remaining target item instances to be provided to the display device 22, as described above regarding 324.

In another embodiment, when the user fails to react to a third threshold number of instances of the target item, a separate video game may be provided to the user 18 via display device 22. In one example, the separate video game may include interactive components that encourage the user 18 to become physically active. In this embodiment, the method 300 may exit the sequence of learning items before all instances of the target item have been provided to the display device 22. The third threshold number of instances may be 3, 4, 5 or any other suitable number of instances. It will be appreciated that in other embodiments, the method 300 may also comprise determining whether the user 18 has failed to react to one or more additional threshold numbers of instances.

Returning to FIGS. 3A and 318, if the user gesture 34 is received within a threshold number of instances of the target item 38, then input received from the sensor 30 is used to determine whether the user gesture 34 is received within a target timeframe corresponding to the target item, as indicated at 326. In one embodiment, the target timeframe may comprise a period of time during which the target item is displayed on the display device 22. For example, the target timeframe may comprise 3 seconds, 4 seconds, 5 seconds, or any other suitable length of time.

In some embodiments, if the user gesture 34 is not received within the target timeframe corresponding to the target item 38, then a first hint may be selected from a hint structure and provided to the display device 22. For example, if the user 18 reacts by performing the user gesture 34 while a learning item that is not the target item 38 is displayed on display device 22, then the user gesture will not be received within the target timeframe. In one example, the hint structure may comprise a file or data structure in the data-holding subsystem 42 that contains multiple hints. The first hint may comprise one or more of audio and visual feedback. In one example, the first hint may comprise audio feedback, such as a voice over prompt provided via display device 22, that informs the user that the user has reacted to a learning item that is not the target item. For example, the voice over prompt may tell the user 18, “Hmmm . . . that's not the letter “G”. Please try again.”

In other embodiments, where the user gesture 34 is not received within the target timeframe corresponding to the target item 38, an incorrect answer instance may be stored in the data-holding subsystem 42, as indicated at 330. As discussed above, the incorrect answer instance may be used in the performance measure provided to the display device 22.

If the incorrect answer instance is a second incorrect answer instance, then the method 300 may provide a second hint that provides different support than the first hint previously provided to the display device 22, as indicated at 332. In one example indicated at 334, the first hint may comprise only audio feedback as described above, and the second hint may comprise audio and visual feedback, such as a character appearing on the display device 22 who reiterates the instructions for the assessment segment to the user 18. In a more specific example, the character may tell the user 18, “I'd like you to throw your ball when you see the letter G.” The character may also demonstrate the target gesture as the letter G appears on the display device 22.

After a hint has been provided, the method 300 may determine whether there are any remaining target item instances to be provided to the display device 22, as indicated at 324 in FIG. 3B and described above. If there are no remaining target items to be provided to the display device 22, then the method 300 may provide to the display device 22 a performance measure, as indicated at 346 and described above. After providing the performance measure, the method 300 may end.

Returning to FIGS. 3A and 326, if the user gesture 34 is received within a target timeframe corresponding to the target item, then the method 300 may proceed to determine whether the user gesture matches the target gesture, as indicated at 336 in FIG. 3B. As explained above, the target gesture may comprise a gesture, motion or other movement made by the user 18 and recognizable by the sensor 30 including, but not limited to, one or more limb motions, jumping motions, clapping motions, etc. In one example, the target gesture may comprise the user 18 clapping his or her hands. In another example, the target gesture may comprise a throwing motion that may simulate, for example, throwing an imaginary ball toward the target item 38 displayed on the display device 22 (as illustrated by the user gesture 34 in FIG. 1). By asking the user 18 to perform a target gesture, the method 300

If the user gesture 34 does not match the target gesture, then a target gesture reminder may be provided to the display device 22, as indicated at 338. In one example, the target gesture reminder may comprise audio feedback, such as a voice over prompt provided via display device 22, that reminds the user to perform the target gesture when the user sees the target item. For example, the voice over prompt may tell the user 18, “Now remember, the Gesture of the Day is jumping. You need to jump when you see the letter G.” In another example, the target gesture reminder may comprise audio and visual feedback, such as a character appearing on the display device 22 who reminds the user 18 to perform the target gesture when the user sees the target item. In a more specific example, the character may verbally remind the user 18 and may demonstrate the target gesture as the letter G appears on the display device 22.

After a target gesture reminder has been provided, the method 300 may determine whether there are any remaining target item instances to be provided to the display device 22, as indicated at 324 in FIG. 3B and described above. If there are no remaining target items to be provided to the display device 22, then the method 300 may provide to the display device 22 a performance measure, as indicated at 346 and described above. After providing the performance measure, the method 300 may end.

Returning to 336, if the user gesture 34 matches the target gesture, then the user 18 has correctly reacted to the target item within the target timeframe corresponding to the target item, and has performed the target gesture. A reward image is then provided to the display device 22 for the user 18, as indicated at 340. In one example, the reward image comprises animated images of sparkles and colorful fireworks, and/or the target item being animated in a festive, celebratory manner. In another example, the reward image may include a character congratulating the user on a correct answer.

In some embodiments, when the user gesture 34 matches the target gesture, a correct answer instance is stored in the data-holding subsystem 42, as indicated at 342. As discussed above, the correct answer instance may be used in the performance measure provided to the display device 22 at 346.

In other embodiments, the reward image may be customized based on one or more factors, as indicated at 344. For example, the reward image may be customized to correspond to the target gesture performed by the user 18. In a more specific example, where the target gesture is a throwing motion that simulates throwing an imaginary ball at the target item 38, the reward image may be customized to simulate a ball impacting the display device and “exploding” into animated sparkles and fireworks.

In another example, the reward image may be customized to correspond to a number of correct answers given by the user 18. In a more specific example, upon the first correct answer the reward image may be customized to display a first level of sparkles and fireworks. Upon the second correct answer, the reward image may be customized to provide a second level of sparkles and fireworks that is greater than the first level. In another example, upon a third correct answer, the reward image may be customized to provide a third level of sparkles and fireworks that is greater than the second level, and may also include a character who praises the user 18. It will be appreciated that other forms, levels and combinations of reward image customization may be provided.

In other embodiments, the pace of the display of the learning items may be increased upon each correct answer given by the user. For example, where an initial pace comprises each learning item remaining on the display for N seconds, upon each correct answer the pace of the display of the learning items may increase such that each learning item remains on the display for N−1 seconds. It will be appreciated that any suitable amount and/or formula for increasing the pace of display of the learning items may be used. In some embodiments, the current pace may be reset to a slower pace when an incorrect answer is given by the user.

After a reward image has been provided, the method 300 may determine whether there are any remaining target item instances to be provided to the display device 22, as indicated at 324 and described above. If there are no remaining target items to be provided to the display device 22, then the method 300 may provide to the display device 22 a performance measure, as indicated at 346 and described above. After providing the performance measure, the method 300 may end.

It will be appreciated that the order of the above-described methods and processes may be varied. For example, upon determining that a user gesture 34 is not within the target timeframe corresponding to a target item, the method 300 may next determine whether the user gesture 34 matches the target gesture. If the user gesture 34 does not match the target gesture, then the method 300 may provide a gesture reminder to the user.

With reference now to FIG. 2 and as mentioned above, computing device 26 may perform one or more of the above-described methods and processes. Computing device 26 is shown in simplified form. It is to be understood that virtually any computer architecture may be used without departing from the scope of this disclosure. In different embodiments, computing device 26 may take the form of a set-top box (e.g. cable television box, satellite television box), digital video recorder (DVR), desktop computer, laptop computer, tablet computer, home entertainment computer, network computing device, etc. Further, in some embodiments the methods and processes described herein may be implemented as a computer application, computer service, computer API, computer library, and/or other computer program product.

As explained above, FIG. 2 shows a non-limiting embodiment of computing device 26 that includes a logic subsystem 40, a data-holding subsystem 42, and a display subsystem 44. Computing device 26 may optionally include a communication subsystem, a sensor subsystem, and/or other components not shown in FIG. 2. Computing device 26 may also optionally include user input devices such as keyboards, mice, game controllers, cameras, microphones, and/or touch screens, for example.

Logic subsystem 40 may include one or more physical devices configured to execute one or more instructions. For example, the logic subsystem 40 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 40 may include one or more processors that are configured to execute software instructions. Additionally or alternatively, the logic subsystem 40 may include one or more hardware or firmware logic machines configured to execute hardware or firmware instructions. Processors of the logic subsystem 40 may be single core or multicore, and the programs executed thereon may be configured for parallel or distributed processing. The logic subsystem 40 may optionally include individual components that are distributed throughout two or more devices, which may be remotely located and/or configured for coordinated processing. One or more aspects of the logic subsystem 40 may be virtualized and executed by remotely accessible networked computing devices configured in a cloud computing configuration.

Data-holding subsystem 42 may include one or more physical, non-transitory, devices configured to hold data and/or instructions executable by the logic subsystem 40 to implement the herein described methods and processes. When such methods and processes are implemented, the state of data-holding subsystem 42 may be transformed (e.g., to hold different data).

Data-holding subsystem 42 may include removable media and/or built-in devices, such as DVD 46. Data-holding subsystem 42 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 42 may include devices with one or more of the following characteristics: volatile, nonvolatile, dynamic, static, read/write, read-only, random access, sequential access, location addressable, file addressable, and content addressable. In some embodiments, logic subsystem 40 and data-holding subsystem 42 may be integrated into one or more common devices, such as an application specific integrated circuit or a system on a chip.

It is to be appreciated that data-holding subsystem 42 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Display subsystem 44 may be used to present a visual representation of data held by data-holding subsystem 42. As the herein described methods and processes change the data held by the data-holding subsystem 42, and thus transform the state of the data-holding subsystem 42, the state of display subsystem 44 may likewise be transformed to visually represent changes in the underlying data. Display subsystem 44 may include one or more display devices, such as display device 22, utilizing virtually any type of technology. Such display devices may be combined with logic subsystem 40 and/or data-holding subsystem 42 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing device, a method of assessing a user's ability to recognize a target item from a collection of learning items that includes the target item, the method comprising:
providing to a display device the learning items in a sequence;
while providing to the display device the learning items in the sequence, receiving input from a sensor to recognize a user gesture made by the user;
determining whether the user gesture is received within a target timeframe corresponding to the target item;
if the user gesture is received within the target timeframe corresponding to the target item, then determining whether the user gesture matches a target gesture; and
if the user gesture matches the target gesture, then providing to the display device a reward image for the user.

2. The method of claim 1, further comprising:
if the user gesture is not received within the target timeframe corresponding to the target item, then:
storing an incorrect answer instance;
selecting a hint from a hint structure; and
providing the hint to the display device for display; and
if the user gesture is received within the target timeframe corresponding to the target item, then storing a correct answer instance.

3. The method of claim 2, further comprising:
if the incorrect answer instance is a first incorrect answer instance, then the hint is a first hint; and
if the incorrect answer instance is a second incorrect answer instance, then the hint is a second hint that provides different support than the first hint previously provided to the display device.

4. The method of claim 3, further comprising presenting the first hint to the user via one or more of audio feedback and visual feedback.

5. The method of claim 2, further comprising:
providing to the display device multiple instances of the target item; and
detecting whether the user gesture is received within the target timeframe corresponding to each instance of the target item; and
providing to the display device a performance measure that relates a number of the correct answer instances to a number of the multiple instances of the target item provided to the display device.

6. The method of claim 1, wherein if the user gesture does not match the target gesture, then providing a target gesture reminder to the display device.

7. The method of claim 1, further comprising:
using the input received from the sensor to determine that the user has not reacted to a threshold number of instances of the target item; and
providing to the display device a reaction reminder that encourages the user to react when the user sees the target item.

8. The method of claim 7, wherein the threshold number is a first threshold number and the reaction reminder is a first reaction reminder that includes audio feedback, and the method further comprising:
using the input received from the sensor to determine that the user has not reacted to a second threshold number of instances of the target item, where the second threshold number is greater than the first threshold number; and
providing to the display device a second reaction reminder that includes audio and visual feedback that encourages the user to react when the user sees the target item.

9. The method of claim 6, wherein the target gesture reminder comprises a character performing the target gesture.

10. The method of claim 1, further comprising customizing the reward image according to the target gesture.

11. The method of claim 1, wherein the sensor comprises a depth camera.

12. The method of claim 1, wherein providing to a display device the learning items in a sequence and providing to the display device the reward image for the user further comprise one or more of synchronously streaming multiple layers of streamed video content to the display device and branching between a first buffered video content portion and a second buffered video content portion.

13. In a computing device, a method of assessing a user's ability to recognize a target item from a collection of learning items that includes the target item, the method comprising:
providing to a display device the learning items in a sequence;
while displaying the learning items in a sequence, receiving from a depth camera image data capturing a user gesture made by the user;
determining whether the user gesture is received within a target timeframe corresponding to the target item;
if the user gesture is not received within the target timeframe corresponding to the target item, then:
storing an incorrect answer instance,
selecting a hint from a hint structure, and
providing the hint to the display device for display;
if the user gesture was performed within the target timeframe, then determining whether the user gesture matches a target gesture;
if the user gesture does not match the target gesture, then providing to the display device a target gesture reminder; and
if the user gesture matches the target gesture, then providing to the display device a reward image for the user.

14. The method of claim 13, wherein the target item is presented as at least a first item and a last item provided to the display device in the sequence.

15. The method of claim 14, wherein the target item comprises one or more of a number or a letter, and the target gesture comprises one or more of a limb motion, a jumping motion or a clapping motion.

16. The method of claim 13, further comprising:
if the incorrect answer instance is a first incorrect answer instance, then the hint is a first hint; and
if the incorrect answer instance is a second incorrect answer instance, then the hint is a second hint that provides different support than the first hint.

17. The method of claim 13, further comprising using image data received from the depth camera to determine that the user has not reacted to a threshold number of instances of the target item; and
providing a reaction reminder to the user that encourages the user to react when the user sees the target item.

18. The method of claim 17, wherein the threshold number is a first threshold number and the reaction reminder is a first reaction reminder that includes audio feedback, further comprising:
using image data received from the depth camera to determine that the user has not reacted to a second threshold number of instances of the target item, where the second threshold number is greater than the first threshold number; and
providing a second reaction reminder to the user including audio feedback and visual feedback on the display device that encourages the user to react when the user sees the target item.

19. A computer readable storage medium excluding signals per se and comprising instructions executable by a computing device to assess a user's ability to recognize a target item from a collection of learning items that includes the target item, the instructions being executable to:
provide to a display device the learning items in a sequence;
while providing the learning items to the display device, receive image data from a sensor and recognize via the image data a user gesture made by the user;
determine whether the user gesture is received within a target timeframe corresponding to the target item;
if the user gesture is received within the target timeframe corresponding to the target item, then determine whether the user gesture matches a target gesture; and
if the user gesture matches the target gesture, then provide to the display device a reward image for the user.

20. The computer readable storage medium of claim 19, wherein the instructions are executable by the computing device to one or more of branch between a first buffered video content and a second buffered video content, and synchronously stream multiple layers of streamed video content to the display device.
